(19) United States
(12) Patent Application Publication
(10) Pub. No.: US 2020/0057990 A1
(43) Pub. Date: Feb. 20, 2020

(54) Unmanned Residential Product Delivery System

(71) Applicant: WFK & Associates, LLC, Gainesville, FL (US)

(72) Inventor: Waldemar F. Kissel, JR., Gainesville, FL (US)

(21) Appl. No.: 16/661,076

(22) Filed: Oct. 23, 2019

Related U.S. Application Data
(63) Continuation of application No. 15/437,053, filed on Feb. 20, 2017.
(60) Provisional application No. 62/297,437, filed on Feb. 19, 2016.

(51) Int. Cl. G06Q 10/08

(52) U.S. Cl. CPC G06Q 10/0832

(57) ABSTRACT

Disclosed is an automated system for the unmanned delivery of packages to neighborhoods and addresses. The system is comprised of a loading phase (FIG. 1), a delivery phase (FIG. 2), and a recycle phase (FIG. 3). In the loading phase, a number of order fulfillment centers process orders for products and thereafter deliver the packaged products to an aggregation facility. The packages associated with a particular neighborhood are then loaded into a consolidated delivery container and consolidated delivery container are loaded in neighborhood containers and neighborhood containers are loaded onto a large delivery vehicle. The large transport vehicle transports the packages to a particular neighborhood. Once in the neighborhood, neighborhood containers are placed on a standby vehicle. The standby vehicle transports the neighborhood container to a target address in a target neighborhood. At the target address a consolidated delivery container is removed from the neighborhood container. The consolidated delivery container, in turn, is placed into a secure location or facility at the intended address by an automated vehicle.

### CROSS REFERENCE TO RELATED APPLICATIONS

This application claims priority to and is a continuation of co-pending application Ser. No. 15/437,053 filed on Feb. 2, 2017, entitled “Unmanned Residential Product Delivery System,” which in turn claims priority to provisional Application Ser. No. 62/297,437 filed on Feb. 19, 2016, entitled “Unmanned Residential Product Delivery System.” The contents of both these co-pending applications are fully incorporated herein for all purposes.

### TECHNICAL FIELD

This disclosure relates to a system for delivering containers to specific location. More particularly, this disclosure relates to an unmanned delivery system for delivering a package to a residential address and returning recycled waste.

### BACKGROUND OF THE INVENTION

Most shoppers are familiar with the aggravation of driving to a shopping mall and the battling the crowds in order to determine if a sought after product is available. This often results in a waste of time if the product is unavailable or if the price is not agreeable to the consumer. For staple items, the process of traveling to a store must be repeated on a weekly or daily basis.

These well-known aggravations have resulted in the dramatic increase of on-line shopping. Consumers are understandably attracted to the ability to easily review and purchase products from the comfort of their home, and thereafter schedule a convenient and timely delivery to their doorstep. Typically, these deliveries are made by U.S. Mail or private carriers. The costs associated with such deliveries, however, can be substantial. For inexpensive products requiring immediate delivery, these transport costs can often exceed the cost of the item.

Efforts are currently underway to automate the delivery of packages to residential addresses. For example, U.S. Pat. 9,536,216 to Lisso and assigned to Amazon Technologies, Inc. is entitled Delivery of Packages by Unmanned Aerial Vehicles. The patent envisions using GPS signals to guide the unmanned aerial vehicle (“UAV”) to a delivery destination. The UAV then adjusts its height via an altimeter to a preferred drop or release height. A camera can allow a human operator to view the delivery destination area. An expandable foam package can surround the package to protect it from the impact of being dropped.

The system of Lisso, however, suffers from many drawbacks. For instance, the UAVs envisioned by Lisso are suitable only for delivering a single item to a single residence. Employing the Lisso system on a large scale would necessarily entail a large number of UAVs as well as associated pilots. This would greatly increase the amount of air traffic and increase the likelihood of interference with human operated aircraft. The Lisso system also requires packages to be dropped from altitude, thereby increasing the likelihood of the package becoming damaged. Lisso also does not in any way secure the package after it has been delivered.

What is needed, therefore, is a unmanned automated system for delivering packages that overcomes these and other shortcomings present in the existing art.

### SUMMARY OF THE INVENTION

It is an objective of this disclosure to provide a delivery process that minimizes the number of vehicles, the miles traveled, and the volume of traffic on the transportation infrastructure in the delivery process and remove recyclable waste and delivery containers.

It is an objective of this disclosure to provide a complete delivery service with a less than 24 hour time span from order until delivery.

It is an objective of this disclosure to make maximum use of expensive capital infrastructure.

Still yet another possible advantage of the present system is to provide a delivery system whereby the package, once delivered, is maintained in a secure and safe location.

Another advantage of the present system is to provide a delivery system whereby the package is not susceptible to damage.

These and other objects are achieved via a system for the automated delivery of common household supplies, such as groceries, medications, pet supplies, clothing, as well as less frequent purchases. This delivery system will considerably reduce the number of trips, save time, save fuel, and provide a great convenience. This delivery system completes the on line shopping cycle. The product is selected on line and delivered by an unmanned vehicle without the pollution of delivery trucks. It is an objective of this disclosure to automate the delivery of all the products from multiple distribution centers direct to the final consumer address in a safe and secure manner.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is schematic showing the first departure phase of the system of the present disclosure.

FIG. 2 is a schematic showing the second arrival phase of the system of the present disclosure.

FIG. 3 is a schematic showing the third recycling phase of the present disclosure.

Similar reference numerals refer to similar components throughout the several view of the drawings.

PARTS LIST

| | | | |
|---|---|---|---|
| 20 | System | 40 | Transfer Location |
| 22 | Order Fulfillment Centers | 48 | Recycle Facility |
| 24 | Aggregation Facility | 52 | Distance Between Aggregator and |
| | | | Transfer Location |
| 26 | Packages | 54 | Distance from Transfer Location to |
| | | | Neighborhood |
| 28 | Large Transport Vehicles | 56 | Distance Traveled to Recycle |
| | | | Facility |
| 32 | Standby Delivery Vehicle | 58 | Distance Traveled from Recycle |
| | | | Facility to Aggregator |
| 34 | Standby Delivery Location | 64 | Consolidated Delivery Container |
| | | | (CDC) |
| 36 | Load Vehicle | 68 | Manned Operations Center |
| 38 | Delivery Address | 74 | Neighborhood Container |

### DETAILED DESCRIPTION OF THE DRAWINGS

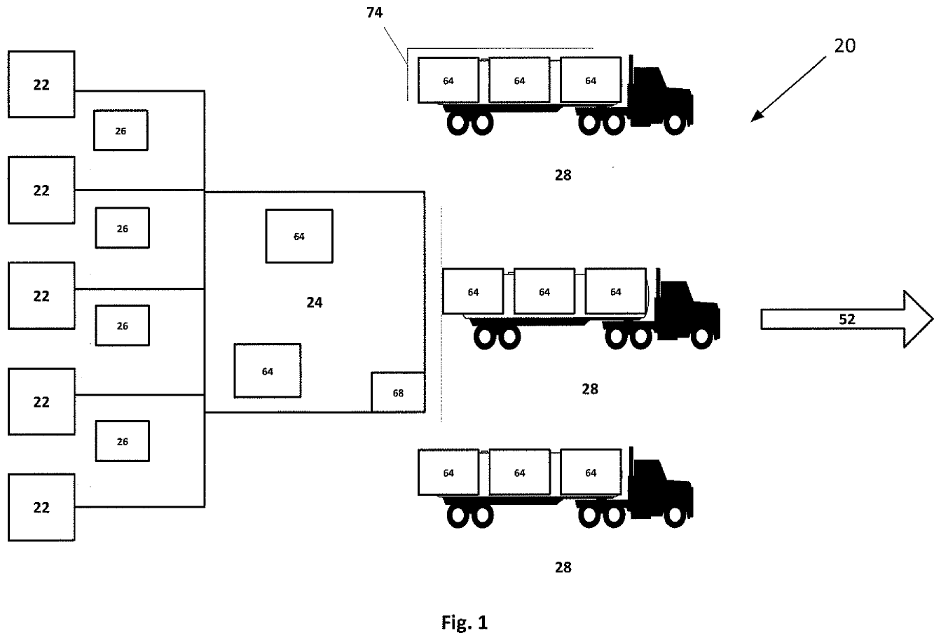

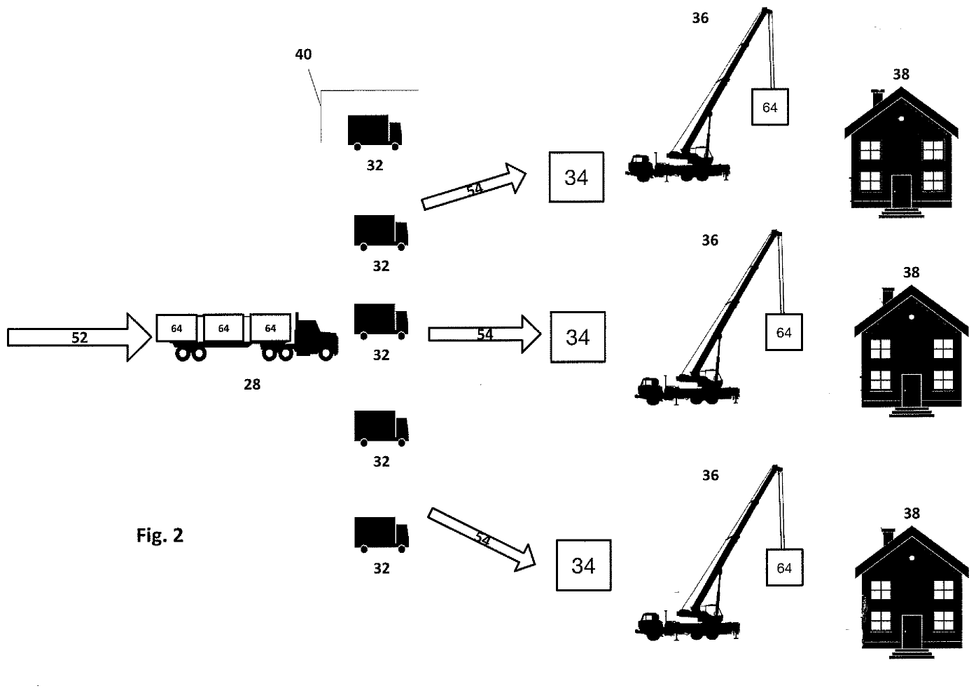

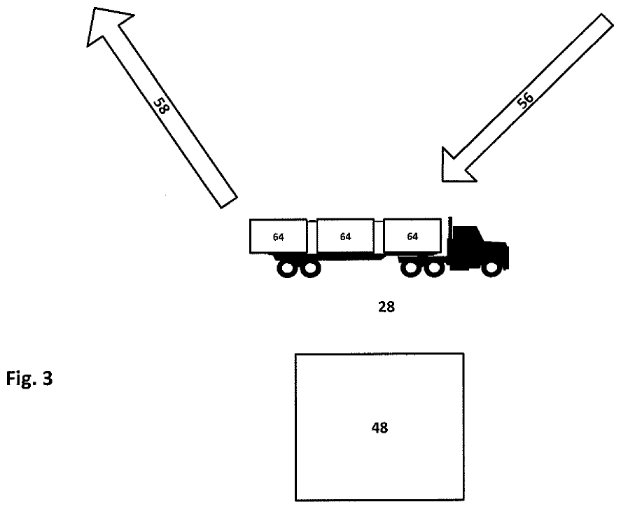

The present disclosure relates to an automated system for the unmanned delivery of packages to neighborhoods and addresses. The system is comprised of a loading phase (FIG. 1), a delivery phase (FIG. 2), and a recycle phase (FIG. 3). In the loading phase, a number of order fulfillment centers process orders for products and thereafter deliver the packaged products to an aggregation facility. The packages associated with a particular address are then loaded into a consolidated delivery container and then into a neighborhood container associated with a neighborhood and neighborhood containers loaded onto a large transport vehicle. The large transport vehicle transports the packages to a particular standby delivery location. The standby delivery vehicle transports the neighborhood container to a target residence load vehicle. The load vehicle removes individual consolidated delivery containers from the neighborhood containers on the standby delivery vehicle. The consolidated delivery container, in turn, is placed into any secure location or facility at the address. The load vehicle can also be used in removing recycled materials from the target residence for transport to a recycling facility.

### Load Phase (FIG. 1)

The load phase of the system is depicted in FIG. 1. It includes a number of different order fulfillment centers (22), an aggregation facility (24), and a number of large transport vehicles (28). The large transport vehicles (28) are used in transporting neighborhood containers over distance (52) to particular neighborhoods.

The plurality of order fulfillment centers (22) process product orders from a plurality of costumers across a plurality of different neighborhoods. They take incoming product orders, process payment, and gather the particular product to be delivered. The fulfillment center (22) is also the location wherein the ordered product is placed into a package and readied for transfer to the aggregation facility.

In order to streamline the delivery process, before a package is transported to a particular target neighborhood, it is first brought to an aggregation facility (24). The aggregation facility (24) is used in gathering a large number of packages from a plurality of different order fulfillment centers (22). It also avoid the need for individual fulfillment centers to have to ship packages to target residences. Instead, at the aggregation facility (24), the packages to be delivered are first segregated by address. In other words, within each aggregation facility (24) the packages are divided into groups in accordance with their target address and placed in consolidated delivery containers. The consolidated delivery containers are then placed in larger neighborhood containers.

A plurality of large transport vehicles (28) are stationed outside the aggregation facility (24). Each large transport vehicle (28) is associated with a particular transfer location (40). The segregated neighborhood containers (74) within the aggregation facility (24) can then be loaded into the associated large transport vehicle (28). The distance between the aggregation facility and the transfer location is indicated by arrow (52).

### Delivery Phase (FIG. 2)

Once a large transport vehicle (28) arrives at the transfer location, it meets up with a plurality of standby delivery vehicles (32). The standby delivery vehicles (32) are stationed near the target neighborhood. A particular standby delivery vehicle (32) can be associated with a particular load vehicle (36). In the alternative, one neighborhood container (74) on one standby vehicle (32) can be associated with multiple target addresses (38). The consolidated delivery containers (64) are offloaded from the neighborhood containers (74) by the load vehicle (36) and delivered to a target address. It is envisioned that the distance traveled by the standby delivery vehicle (32) will be considerably shorter than the distance traveled by the large transport vehicles (28).

Upon arrival at the target address (38), the consolidated delivery container (64) is unloaded from a neighborhood container (74). Consolidated delivery container (64) may be more secure and may limit access to only the consumer. It may also be dimensioned and built to fit within and withstand delivery. The consolidated delivery container (64) is deposited into a secure location at the target address (38) via a load vehicle (36). The load vehicle (36) may either be permanently stationed in a neighborhood or it may rove between nearby neighborhoods. Load vehicle (36) may be a mobile crane or an automated vehicle that can lift consolidated delivery container (64) and transport it into a designated secure location.

### Recycle Phase (FIG. 3)

FIG. 3 illustrates the recycle phase of the system. In this phase, the load vehicle (36) is used to retrieve trash, garbage, recyclable packaging, or recyclable materials from the address (38). These materials are then loaded into a neighborhood container on a standby delivery vehicle, (32) transferred to a large transport vehicle (28) and transported over distance (56) to a recycling facility (48) or trash dump. Upon delivering the materials, vehicle (28) returns to the aggregator facility (24) as indicated by arrow (58).

The ordering and automated delivery process begins with an on line order to an order fulfillment center (20). There may be several orders to many order fulfillment centers (22) (including local retailers, brick and mortar suppliers). The order is delivered to an aggregator (24) (such as U.S. Post Office, UPS, or FedEx). The aggregator (24) gathers all the orders going to each delivery address (38), packs them in appropriate consolidated delivery containers (64), groups them according to neighboring address and places them in a neighborhood container (74). Several of these neighborhood containers (74) are placed onto a large transport vehicle (28). There are many miles (52) between the aggregation and the transfer location (40). There may be as many as several hundred miles (52) from an aggregator to the transfer location. The large transfer vehicles (28) meet with the standby delivery vehicles (32) at a prearranged location. The large transport vehicles transfers a full neighborhood container onto each empty standby delivery vehicle.

Each standby delivery vehicle then travels (54) to a designated location meet up with load vehicle (36). The load vehicle is a mobile platform with an appropriately designed apparatus that is operated by software in the system to move consolidated delivery containers from standby delivery vehicle to a safe and secure location at the delivery address. This load vehicle remains in the neighborhoods continuously.

### Additional Embodiments

In accordance with additional embodiments, the packages, consolidated delivery containers (64), or neighborhood container (74) can include both permanent and temporary markings. For example, permanent marking can be information relating to the product, product codes, and other product information. And temporary markings can be related to information about the intended customer, such as their name, address, or phone number.

The target residence (38) may include any secure location or facility for depositing delivery containers for use in delivering materials to and removing recycled material from the target residence (38).

Load vehicle (36) may have multiple degrees freedom and further include an extendable arm with the appropriate accessories to reach for, attach itself to and remove recycling containers or otherwise designated recycling location and place them in a consolidated delivery container, placed into a neighborhood container and onto a standby delivery vehicle.

When one standby delivery vehicle is empty, it leaves and a full standby delivery vehicle (32) replaces it. The load vehicle (36) has information from the aggregator operations center (68) providing local information. The load vehicle (36) moves to the next address, follows a sensor or signal to the next designated secure location. The delivery arm (36) looks for, grasps, and removes any delivery containers with recyclable materials. The delivery arm places the consolidated delivery container into the neighborhood container on standby vehicle and then picks up consolidated delivery containers and delivers them to the address. This completes one delivery cycle. The load vehicle moves onto the next address. The load vehicle repeats this process 24 hours a day, every day of the week. Each time a standby delivery vehicle is emptied and refilled with recycled materials it travels to a nearby tracking transfer location (28) where it exchanges recycling neighborhood container for a full neighborhood container and returns to the load vehicle. The load vehicle is charged by the standby delivery vehicle. The standby delivery vehicle is charged by the large transport vehicles. The large transport vehicles are charged while at the aggregation facility.

After a large transport vehicle has unloaded all its containers and received all the recycling containers the vehicle (28) travels many miles (56) to a Recycling Facility (48). Then the large transport vehicle returns several miles (58) to the aggregator to receive another load.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. An automated delivery system for use in delivering shipping containers to target addresses in target neighborhoods, the system comprising:
a first vehicle remaining continuously within a target neighborhood and continuously delivering shipping containers to target residences;
a second vehicle containing a supply of shipping containers, collected, aggregated and organized for systematic delivery within a given target neighborhood.

2. The system as described in claim 1 wherein the first and second vehicles work together to continuously supply full containers, a first vehicle that remains permanently on the job in a neighborhood continuously removing waste or recycled materials and replacing same with fresh containers into a safe, secure location at target addresses.

3. The system as described in claim 2 further comprising operators in a remote location for monitoring operations and also guiding the actual operation of the load vehicle when necessary.

4. An automated delivery system for delivering items ordered by a consumer to a target residence, the system comprising:
a plurality of order fulfillment centers (22), each of the order fulfillment centers (22) processing product orders from a plurality of residences (38) across a plurality of different neighborhoods, an ordered product being placed into a package (26);
an aggregation facility (24) for gathering a plurality of packages (26) from the plurality of order fulfillment centers (22), the plurality of packages (26) being segregated in accordance with the specified residences (38) and specified neighborhoods to which the packages (26) are to be delivered;
a plurality of Consolidated Delivery Containers (“CDC”) (64), all of the packages (26) for the target residence (38) being placed into a specified CDC (64);
a neighborhood container (74) containing all the CDCs (64) for a specified neighborhood;
a large transport vehicle (28) for delivering the neighborhood container (74) to a transfer location (40);
a plurality of standby delivery vehicles (32), a specified standby delivery vehicle (32) adapted to receive the neighborhood container (74) from the large transport vehicle (28);
a load vehicle (36) for removing a CDC (64) from the neighborhood container (74) and delivering it into the target residence (38).

5. The system as described in claim 4 wherein the CDCs (64) are permanently marked with information relating to the product.

6. The system as described in claim 4 wherein the CDC's (64) are temporarily marked with information relating to the intended customer.

7. The system as described in claim 4 wherein the CDCs (64) are used both for delivering products to the target residence (38) and for removing recycled materials from the target residence (38).
